(19) United States
(12) Patent Application Publication
(10) Pub. No.: US 2021/0090776 A1
(43) Pub. Date: Mar. 25, 2021

(54) IN-VEHICLE MOTOR-DRIVEN COMPRESSOR

(71) Applicant: KABUSHIKI KAISHA TOYOTA JIDOSHOKKI, Kariya-shi (JP)

(72) Inventors: Hiroshi FUKASAKU, Kariya-shi (JP); Yoshiki NAGATA, Kariya-shi (JP); Junya KAIDA, Kariya-shi (JP); Shunsuke AMBO, Kariya-shi (JP); Takashi KAWASHIMA, Kariya-shi (JP)

(73) Assignee: KABUSHIKI KAISHA TOYOTA JIDOSHOKKI, Kariya-shi (JP)

(21) Appl. No.: 17/017,938

(22) Filed: Sep. 11, 2020

(30) Foreign Application Priority Data
Sep. 25, 2019 (JP) 2019-174303

(51) Int. Cl. H01F 17/04; H02P 27/08; H01F 27/28; H01F 41/066; B60R 16/03; F04D 25/06

(52) U.S. Cl. CPC H01F 17/04; H02P 27/08; H01F 27/2823; H01F 2017/0093; B60R 16/03; F04D 25/0693; H01F 41/066

(57) ABSTRACT

An in-vehicle motor-driven compressor includes a common mode choke coil. The common mode choke coil includes an annular core having a through-hole, a first winding and a second winding wound around the core, and a coated conductive wire. The second winding is opposed to the first winding while being spaced apart from the first winding. The coated conductive wire is wound around the core so as to surround the first winding, the second winding, and the core. The coated conductive wire has sections that are opposed to each other with the through-hole in between. An electric wire of the coated conductive wire is wound multiple turns around the core so as to at least partly overlap with the first and second windings. Both ends of the electric wire are electrically connected to each other. The core includes an exposed section that is not covered with the coated conductive wire.

### BACKGROUND

### 1. Field

The present disclosure relates to an in-vehicle motor-driven compressor.

### 2. Description of Related Art

International Publication WO 2017/170817 discloses a choke coil covered with a conductor as a configuration of a common mode choke coil used in an inverter device that drives an electric motor in an in-vehicle motor-driven compressor. When a normal-mode current flows through such a choke coil, leakage magnetic flux is generated. The leakage magnetic flux in turn causes an induced current to flow through the conductor. The induced current is converted into a thermal energy in the conductor. The choke coil thus has a damping effect.

In a case where a choke coil is entirely covered with a conductor, the heat is likely to be trapped inside. On the other hand, if a choke coil is designed to have a section not covered with a conductor in order to enhance the heat radiation performance, induced current would not flow readily in that section, reducing the damping effect.

### SUMMARY

Accordingly, it is an objective of the present disclosure to provide an in-vehicle motor-driven compressor having a filter circuit with superior heat radiation performance and damping effect.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an in-vehicle motor-driven compressor is provided that includes a compression unit configured to compress fluid, an electric motor configured to drive the compression unit, and an inverter device configured to drive the electric motor. The inverter device includes an inverter circuit configured to convert DC power to AC power, and a noise reducing unit that is provided on an input side of the inverter circuit and is configured to reduce common mode noise and normal mode noise included in the DC power before the DC power is supplied to the inverter circuit. The noise reducing unit includes a common mode choke coil and a smoothing capacitor that makes up a low-pass filter circuit together with the common mode choke coil. The common mode choke coil includes an annular core that includes a through-hole, a first winding wound around the core, a second winding wound around the core, and a single coated conductive wire. The second winding is opposed to the first winding while being spaced apart from the first winding. The single coated conductive wire is wound around the core so as to surround the first winding, the second winding, and the core. The coated conductive wire includes sections that are opposed to each other with the through-hole in between. The coated conductive wire includes an electric wire and an insulating material coating the electric wire. The electric wire is wound multiple turns around the core so as to at least partly overlap with the first winding and the second winding. One end and another end of the electric wire are electrically connected to each other. The core includes an exposed section that is not covered with the coated conductive wire.

In another aspect, an in-vehicle motor-driven compressor is provided that includes a compression unit configured to compress fluid, an electric motor configured to drive the compression unit, and an inverter device configured to drive the electric motor. The inverter device includes an inverter circuit configured to convert DC power to AC power, and a noise reducing unit that is provided on an input side of the inverter circuit and is configured to reduce common mode noise and normal mode noise included in the DC power before the DC power is supplied to the inverter circuit. The noise reducing unit includes a common mode choke coil and a smoothing capacitor that makes up a low-pass filter circuit together with the common mode choke coil. The common mode choke coil includes an annular core that includes a through-hole, a first winding wound around the core, a second winding wound around the core, and multiple coated conductive wires. The second winding is opposed to the first winding while being spaced apart from the first winding. The coated conductive wires are wound around the core so as to surround the first winding, the second winding, and the core and include sections that are opposed to each other with the through-hole in between. The coated conductive wires each include an electric wire and an insulating material coating the electric wire. Each of the coated conductive wires is wound one or more turns around the core. One end and an other end of the electric wire are electrically connected to each other for each of the coated conductive wires. The core includes an exposed section that is not covered with any of the coated conductive wires.

Other features and aspects will be apparent from the following detailed description, the drawings, and the claims.

### BRIEF DESCRIPTION OF THE DRAWINGS

FIG. 1 is a diagrammatic view showing an in-vehicle motor-driven compressor.

FIG. 2 is a circuit diagram of a driving device and an electric motor in the motor-driven compressor shown in FIG. 1.

FIG. 3A is a plan view of a common mode choke coil according to a first embodiment.

FIG. 3B is a front view of the common mode choke coil shown in FIG. 3A.

FIG. 3C is a right side view of the common mode choke coil shown in FIG. 3A.

FIG. 3D is a cross-sectional view taken along line 3D-3D of FIG. 3A.

FIG. 4A is a plan view of a core and windings.

FIG. 4B is a front view of the core and the windings shown in FIG. 4A.

FIG. 4C is a right side view of the core and the windings shown in FIG. 4A.

FIG. 5 is a perspective view illustrating an operation of the core and the windings.

FIG. 6 is a perspective view illustrating an operation of the common mode choke coil.

FIG. 7 is a graph showing the frequency characteristic of the gain of a low-pass filter circuit.

FIG. 8 is a plan view of a common mode choke coil according to a modification.

FIG. 9 is a plan view of a common mode choke coil according to a modification.

FIG. 10 is a plan view of a common mode choke coil according to a modification.

FIG. 11A is a plan view of a common mode choke coil according to a modification.

FIG. 11B is a front view of the common mode choke coil shown in FIG. 11A.

FIG. 11C is a right side view of the common mode choke coil shown in FIG. 11A.

FIG. 12A is a perspective view showing a coated conductive wire.

FIG. 12B is a perspective view showing a coated conductive wire according to a modification.

FIG. 13A is a plan view of a common mode choke coil according to a second embodiment.

FIG. 13B is a front view of the common mode choke coil shown in FIG. 13A.

FIG. 13C is a right side view of the common mode choke coil shown in FIG. 13A.

FIG. 13D is a cross-sectional view taken along line 13D-13D of FIG. 13A.

FIG. 14A is a plan view of a common mode choke coil of a comparative example.

FIG. 14B is a front view of the common mode choke coil shown in FIG. 14A.

FIG. 14C is a right side view of the common mode choke coil shown in FIG. 14A.

FIG. 14D is a cross-sectional view taken along line 14D-14D of FIG. 14A.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

### First Embodiment

An in-vehicle motor-driven compressor 11 according to a first embodiment will now be described with reference to the drawings. The in-vehicle motor-driven compressor 11 of the present embodiment includes a compression unit 18 that compresses fluid, which is refrigerant, and is used in an in-vehicle air conditioner 10. That is, the fluid to be compressed in the in-vehicle motor-driven compressor 11 in the present embodiment is a refrigerant.

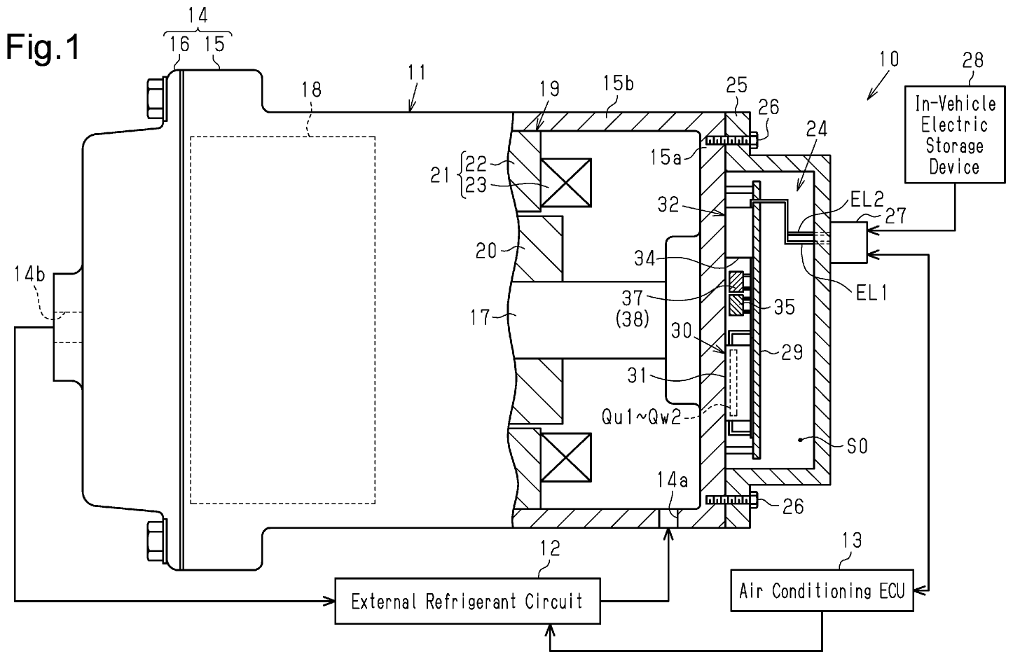

As shown in FIG. 1, the in-vehicle air conditioner 10 includes the in-vehicle motor-driven compressor 11 and an external refrigerant circuit 12. The external refrigerant circuit 12 supplies fluid, which is a refrigerant, to the in-vehicle motor-driven compressor 11. The external refrigerant circuit 12 includes, for example, a heat exchanger and an expansion valve. The in-vehicle motor-driven compressor 11 compresses the refrigerant, and the external refrigerant circuit 12 performs heat exchange and expansion of the refrigerant. Accordingly, the in-vehicle air conditioner 10 cools or warms the passenger compartment.

The in-vehicle air conditioner 10 includes an air conditioning ECU 13 that controls the entire in-vehicle air conditioner 10. The air conditioning ECU 13 is configured to obtain parameters such as the temperature of the passenger compartment and a set target temperature. Based on the parameters, the air conditioning ECU 13 outputs various commands such as an ON-OFF command to the in-vehicle motor-driven compressor 11.

The in-vehicle motor-driven compressor 11 includes a housing 14 that has a suction port 14a, through which refrigerant is drawn from the external refrigerant circuit 12.

The housing 14 is made of a thermally conductive material, for example, a metal such as aluminum. The housing 14 is grounded to the body of the vehicle.

The housing 14 includes a suction housing member 15 and a discharge housing member 16, which are assembled together. The suction housing member 15 is a tubular body with an opening at one end and has an end wall 15a and a circumferential wall 15b, which extends from the periphery of the end wall 15a toward the discharge housing member 16. The end wall 15a has, for example, a substantially plate-like shape, and the circumferential wall 15b has, for example, a substantially tubular shape. The discharge housing member 16 is attached to the suction housing member 15 while closing the opening of the suction housing member 15. Accordingly, an internal space is defined in the housing 14.

The suction port 14a is provided in the circumferential wall 15b of the suction housing member 15. Specifically, the suction port 14a is arranged in a section of the circumferential wall 15b of the suction housing member 15 that is closer to the end wall 15a than to the discharge housing member 16.

The housing 14 has a discharge port 14b, through which refrigerant is discharged. The discharge port 14b is provided in the discharge housing member 16, specifically, in a section of the discharge housing member 16 that is opposed to the end wall 15a.

The in-vehicle motor-driven compressor 11 includes a rotary shaft 17, a compression unit 18, and an electric motor 19, which are accommodated in the housing 14.

The rotary shaft 17 is rotationally supported by the housing 14. The rotary shaft 17 is arranged with its axial direction coinciding with the thickness direction of the end wall 15a (in other words, the axial direction of the circumferential wall 15b). The rotary shaft 17 and the compression unit 18 are coupled to each other.

The compression unit 18 is arranged in the housing 14 at a position closer to the discharge port 14b than to the suction port 14a (in other words, than to the end wall 15a). When the rotary shaft 17 rotates, the compression unit 18 compresses refrigerant that has been drawn into the housing 14 through the suction port 14a and discharges the compressed refrigerant through the discharge port 14b. The specific configuration of the compression unit 18 is not particularly limited and may be any type such as a scroll type, a piston type, or a vane type.

The electric motor 19 is arranged in the housing 14 between the compression unit 18 and the end wall 15a. The electric motor 19 rotates the rotary shaft 17 to drive the compression unit 18. The electric motor 19 includes, for example, a cylindrical rotor 20 fixed to the rotary shaft 17 and a stator 21 fixed to the housing 14. The stator 21 includes a cylindrical stator core 22 and coils 23 wound around the teeth of the stator core 22. The rotor 20 and the stator 21 are opposed to each other in the radial direction of the rotary shaft 17. When the coils 23 are energized, the rotor 20 and the rotary shaft 17 rotate, so that the compression unit 18 compresses refrigerant.

As shown in FIG. 1, the in-vehicle motor-driven compressor 11 includes a driving device 24 and a cover member 25. The driving device 24 drives the electric motor 19 and receives DC power. The cover member 25 defines an accommodation chamber S0, which accommodates the driving device 24.

The cover member 25 is made of a nonmagnetic and conductive material with heat conductivity, for example, a metal such as aluminum.

The cover member 25 is a tubular body with an opening at one end, opens to the housing 14, specifically, to the end wall 15a of the suction housing member 15. The cover member 25 is attached to the end wall 15a by bolts 26 with the open end abutting against the end wall 15a. The opening of the cover member 25 is closed by the end wall 15a. The accommodation chamber S0 is defined by the cover member 25 and the end wall 15a.

The accommodation chamber S0 is arranged outside the housing 14 and is located on the opposite side of the end wall 15a from the electric motor 19. The compression unit 18, the electric motor 19, and the driving device 24 are arranged in the axial direction of the rotary shaft 17.

The cover member 25 includes a connector 27, which is electrically connected to the driving device 24. DC power is supplied to the driving device 24 from an in-vehicle electric storage device 28 via the connector 27. The air conditioning ECU 13 and the driving device 24 are electrically connected to each other via the connector 27. The in-vehicle electric storage device 28 is a DC power supply mounted on the vehicle, which is, for example, a rechargeable battery, a capacitor, or the like.

As shown in FIG. 1, the driving device 24 includes a circuit board 29, an inverter device 30 provided on the circuit board 29, and two connection lines EL1, EL2, which electrically connect the connector 27 and the inverter device 30 to each other.

The circuit board 29 is shaped like a plate. The circuit board 29 is arranged to be opposed to the end wall 15a at a predetermined distance in the axial direction of the rotary shaft 17.

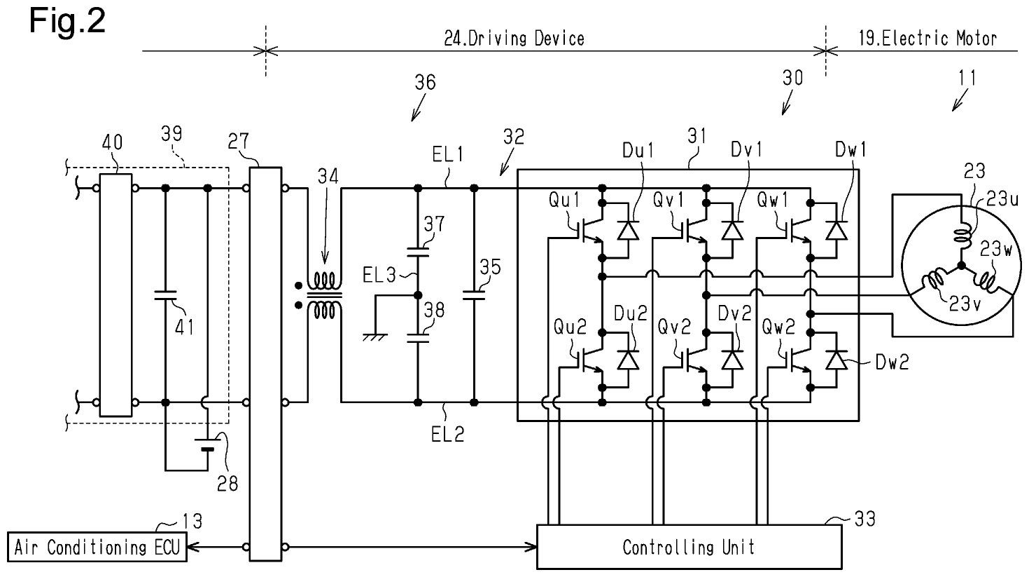

The inverter device 30 is configured to drive the electric motor 19. The inverter device 30 includes an inverter circuit 31 (see FIG. 2) and a noise reducing unit 32 (see FIG. 2). The inverter circuit 31 is configured to convert DC power into AC power. The noise reducing unit 32 is provided on the input side of the inverter circuit 31 and is configured to reduce common mode noise and normal-mode noise included in the DC power before the DC power is supplied to the inverter circuit 31.

Next, the electrical configuration of the electric motor 19 and the driving device 24 will be described.

As shown in FIG. 2, the coils 23 of the electric motor 19 are of a three-phase structure, for example, with a U-phase coil 23u, a V-phase coil 23v, and a W-phase coil 23w. The coils 23u to 23w are connected in a Y-connection.

The inverter circuit 31 includes U-phase switching elements Qu1, Qu2, which correspond to the U-phase coil 23u, V-phase switching elements Qv1, Qv2, which correspond to the V-phase coil 23v, and W-phase switching elements Qw1, Qw2, which correspond to the W-phase coil 23w. Each of the switching elements Qu1 to Qw2 is, for example, a power switching element such as an IGBT. The switching elements Qu1 to Qw2 respectively include freewheeling diodes (body diodes) Du1 to Dw2.

The U-phase switching elements Qu1, Qu2 are connected to each other in series by a connection wire that is connected to the U-phase coil 23u. The serially-connected body of the U-phase switching elements Qu1, Qu2 is electrically connected to the connection lines EL1, EL2. The serially-connected body receives DC power from the in-vehicle electric storage device 28 via the connection lines EL1, EL2.

Except for the connected coil, the other switching elements Qv1, Qv2, Qw1, Qw2 have the same connection structure as the U-phase power switching elements Qu1, Qu2.

The driving device 24 includes a controlling unit 33, which controls switching operations of the switching elements Qu1 to Qw2. The controlling unit 33 may be a processing circuit that includes, for example, at least one dedicated hardware circuit and/or at least one processor that operates in accordance with a computer program (software). The processor includes a CPU and a memory such as a RAM and a ROM. The memory stores program codes or commands configured to cause the processor to execute various processes. The memory, or a computer readable medium, includes any type of medium that is accessible by a general-purpose computer or a dedicated computer.

The controlling unit 33 is electrically connected to the air conditioning ECU 13 via the connector 27. Based on commands from the air conditioning ECU 13, the controlling unit 33 periodically turns on and off the switching elements Qu1 to Qw2. Specifically, based on commands from the air conditioning ECU 13, the controlling unit 33 performs pulse width modulation control (PWM control) on the switching elements Qu1 to Qw2. More specifically, the controlling unit 33 uses a carrier signal and a commanded voltage value signal (signal for comparison) to generate control signals. The controlling unit 33 performs ON-OFF control of the switching elements Qu1 to Qw2 by using the generated control signals, thereby converting DC power to AC power.

The noise reducing unit 32 has a common mode choke coil 34 and an X capacitor 35. The X capacitor 35, which is a smoothing capacitor, makes up a low-pass filter circuit 36 together with the common mode choke coil 34. The low-pass filter circuit 36 is provided on the connection lines EL1, EL2. Regarding the relationship with other circuits, the low-pass filter circuit 36 is provided between the connector 27 and the inverter circuit 31.

The common mode choke coil 34 is provided on the connection lines EL1, EL2.

The X capacitor 35 is provided on the output stage of the common mode choke coil 34 (on the side closer on which the inverter circuit 31 is located) and is electrically connected to the connection lines EL1, EL2. A normal mode inductance generated by the leakage magnetic flux from the common mode choke coil 34 and the X capacitor 35 make up an LC resonance circuit. That is, the low-pass filter circuit 36 of the present embodiment is an LC resonance circuit including the common mode choke coil 34.

Y capacitors 37, 38 are connected in series. Specifically, the driving device 24 includes a bypass line EL3 that connects a first end of the first Y capacitor 37 and a first end of the second Y capacitor 38 to each other. The bypass line EL3 is grounded to the body of the vehicle.

The serially-connected body made up of the Y capacitors 37, 38 is provided between the common mode choke coil 34 and the X capacitor 35 and is electrically connected to the common mode choke coil 34. A second end of the first Y capacitor 37 on the side opposite to the first end is connected to the first connection line ELL more specifically, to a section of the first connection line EL1 that connects the first winding of the common mode choke coil 34 and the inverter circuit 31 to each other. A second end of the second Y capacitor 38 on the side opposite to the first end is connected to the second connection line EL2, more specifically, to a section of the second connection line EL2 that connects the second winding of the common mode choke coil 34 and the inverter circuit 31 to each other.

The in-vehicle devices of the vehicle include, for example, a power control unit (PCU) 39, which is provided separately from the driving device 24. The PCU 39 uses DC power from the in-vehicle electric storage device 28 to drive a vehicle-driving motor mounted in the vehicle. That is, in the present embodiment, the PCU 39 and the driving device 24 are connected in parallel to the in-vehicle electric storage device 28, and the in-vehicle electric storage device 28 is shared by the PCU 39 and the driving device 24.

The PCU 39 includes a boost converter 40 and a power supply capacitor 41. The boost converter 40 includes a boost switching element. The power supply capacitor 41 is connected in parallel with the in-vehicle electric storage device 28. The boost converter 40 periodically turns the boost switching element on and off to boost the DC power supplied from the in-vehicle electric storage device 28. Although not illustrated, the PCU 39 includes a vehicle-driving inverter that converts the DC power boosted by the boost converter 40 to power that drives the vehicle-driving motor.

In the above described configuration, noise is generated by switching actions of the boost switching element. The noise flows into the driving device 24 as normal-mode noise. In other words, the normal-mode noise includes a noise component corresponding to the switching frequency of the boost switching element.

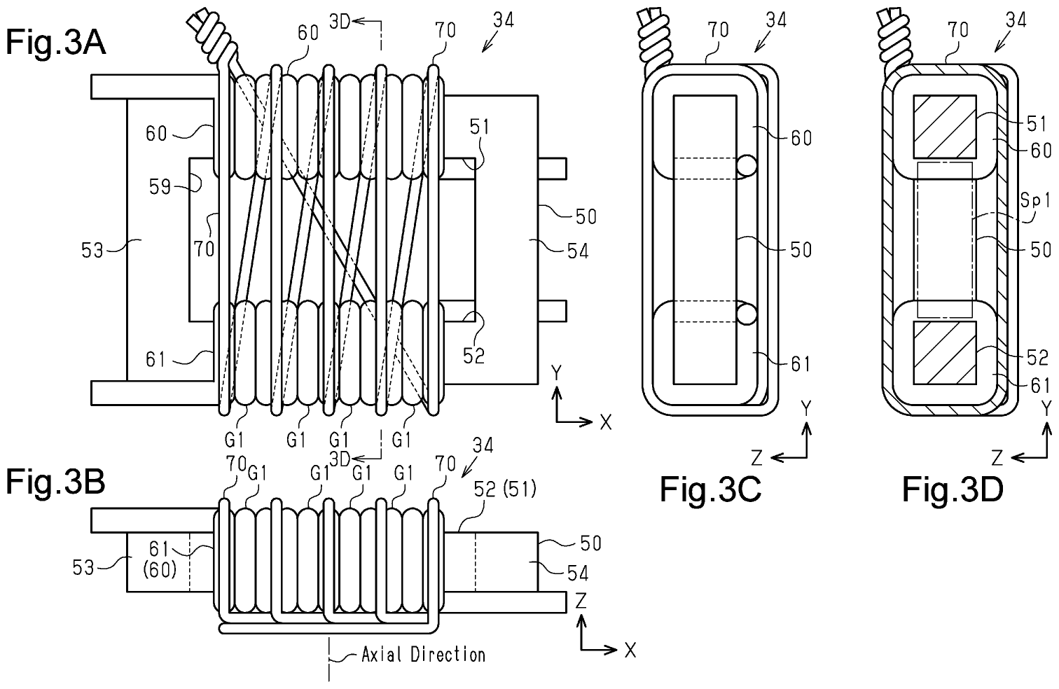

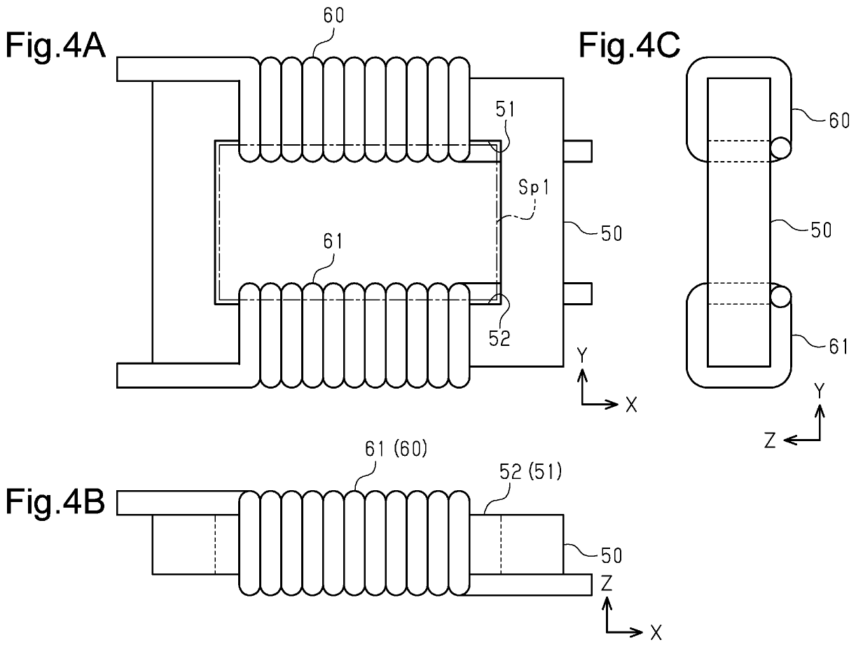

Next, the configuration of the common mode choke coil 34 will be described with reference to FIGS. 3A, 3B, 3C, 3D, 4A, 4B, and 4C.

The common mode choke coil 34 is configured to limit transmission of high frequency noise generated in the PCU 39 to the inverter circuit 31. In particular, the common mode choke coil 34 is used as an L component in the low-pass filter circuit (LC filter) 36 that eliminates the normal mode noise (differential mode noise) by utilizing the leakage inductance as a normal inductance. That is, the single common mode choke coil 34 can cope with the common mode noise and the normal mode noise (differential mode noise). Thus, there is no need to use a common mode choke coil and a normal choke (differential mode) coil, separately.

In the drawings, a three-axis orthogonal coordinate system is defined in which the axial direction of the rotary shaft 17 in FIG. 1 is defined as the Z-direction, and the directions orthogonal to the Z-direction are defined as the X- and Y-directions.

As shown in FIGS. 3A, 3B, 3C, and 3D, the common mode choke coil 34 includes an annular core 50, a first winding 60, a second winding 61, and an enameled wire 70, which is a single coated conductive wire. The term “annular” as used in this description may refer to any structure that forms a loop, or a continuous shape with no ends. “Annular” shapes include but are not limited to a circular shape, an elliptic shape, and a polygonal shape with sharp or rounded corners.

The core 50 includes a through-hole 59 on the inner side as shown in FIG. 3A and has a quadrangular cross section as shown in FIG. 3D, and has a rectangular shape as a whole in the X-Y plane shown in FIG. 4A. As shown in FIGS. 3D and 4A, the core 50 has an inner space Sp1 that is formed by the through-hole 59.

As shown in FIGS. 4A, 4B, 4C, the first winding 60 is wound around the core 50, and the second winding 61 is wound around the core 50. Specifically, the core 50 has a first straight section 51 and a second straight section 52, which are parallel with each other as shown in FIG. 4A. The first straight section 51 and the second straight section 52 correspond to the two long sides of the rectangular core 50. That is, the core 50 has the first straight section 51 and the second straight section 52, which extend linearly so as to be parallel with each other. The first winding 60 is wound around the first straight section 51, and the second winding 61 is wound around the second straight section 52. That is, at least a part of the first winding 60 is wound around the first straight section 51, and at least a part of the second winding 61 is wound around the second straight section 52. The winding directions of the two windings 60 and 61 are opposite to each other. Further, the first winding 60 and the second winding 61 are opposed to each other while being separated from each other.

A plastic case (not shown) is provided between the core 50 and the windings 60 and 61. A protrusion (not shown) extends from the plastic case. The enameled wire 70 is restricted from moving by contacting the protrusion.

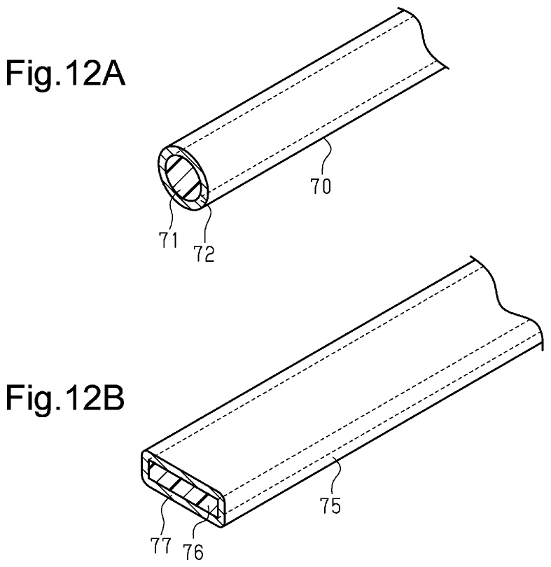

The enameled wire 70 shown in FIGS. 3A, 3B, 3C, and 3D includes a circular wire 71, which is a copper electric wire, and enamel 72, which is an insulating material coating the circular wire 71. That is, as shown in FIG. 12A, the enamel 72 coats the surface of the circular wire 71, which has a cross section of a perfect circle.

As shown in FIGS. 3C and 3D, the enameled wire 70 is wound to surround the core 50, while extending over the first winding 60 and the second winding 61. Specifically, the enameled wire 70 is configured to cover or surround the first winding 60, the second winding 61, and the inner space Sp1 (refer to FIGS. 3D and 4A) of the core 50. That is, the enameled wire 70 surrounds the first winding 60, the second winding 61, and the core 50. In a broad sense, the enameled wire 70 is configured to cover or surround at least sections of the first winding 60, the second winding 61, and the inner space Sp1 (refer to FIGS. 3D and 4A) of the core 50. The inner space Sp1, which is formed by the through-hole 59, exists between the first winding 60 and the second winding 61. The enameled wire 70 includes sections that are opposed to each other with the through-hole 59 in between. In other words, between the first winding 60 and the second winding 61, sections of the enameled wire 70 are separated from each other with the inner space Sp1 in between. That is, between the first winding 60 and the second winding 61, the sections of the enameled wire 70 that are separated from each other with the inner space Sp1 in between are not electrically connected to each other.

As shown in FIG. 3A, the two short sides of the quadrangular core 50 are exposed sections 53, 54, which are not covered with the enameled wire 70.

In a broad sense, the enameled wire 70 is wound multiple turns around the core 50 so as to at least partly overlap with (pass over) the first winding 60 and the second winding 61. The enameled wire 70 at least partially covers sections of the first winding 60 and the second winding 61 that are on the radially outer side of the core 50. The sections of the first winding 60 and the second winding 61 that are on the radially outer side of the core 50 refer to sections that are visible in a front view of the first winding 60 and the second winding 61 (refer to FIG. 4B). In the present embodiment, the number of turns of the enameled wire 70 is five. The number of turns of the enameled wire 70 is not particularly limited.

The circular wire 71 is wound multiple turns around the core 50 so as to at least partly overlap with the first winding 60 and the second winding 61. One end and the other end of the circular wire 71 are electrically connected to each other by being twisted together. The ends of the circular wire 71 may be soldered to each other after being twisted together.

The enameled wire 70 includes extending sections that extend between the first winding 60 and the second winding 61. These extending sections are arranged in the extending direction of the core 50 (X-direction) as viewed in FIG. 3A. In a front view of the through-hole 59, that is, when the through-hole 59 is seen in the axial direction of the core 50 (refer to FIG. 3B), a gap G1 is provided between each adjacent pair of the extending sections of the enameled wire 70. The extending sections of the enameled wire 70 are evenly disposed in the extending direction of the core 50 (X-direction) as viewed in FIG. 3A.

The extending sections of the enameled wire 70 extend in the Y-direction, which is orthogonal to the extending direction of the core 50 in FIG. 3A (X-direction), and are parallel with each other.

Next, an operation will be described.

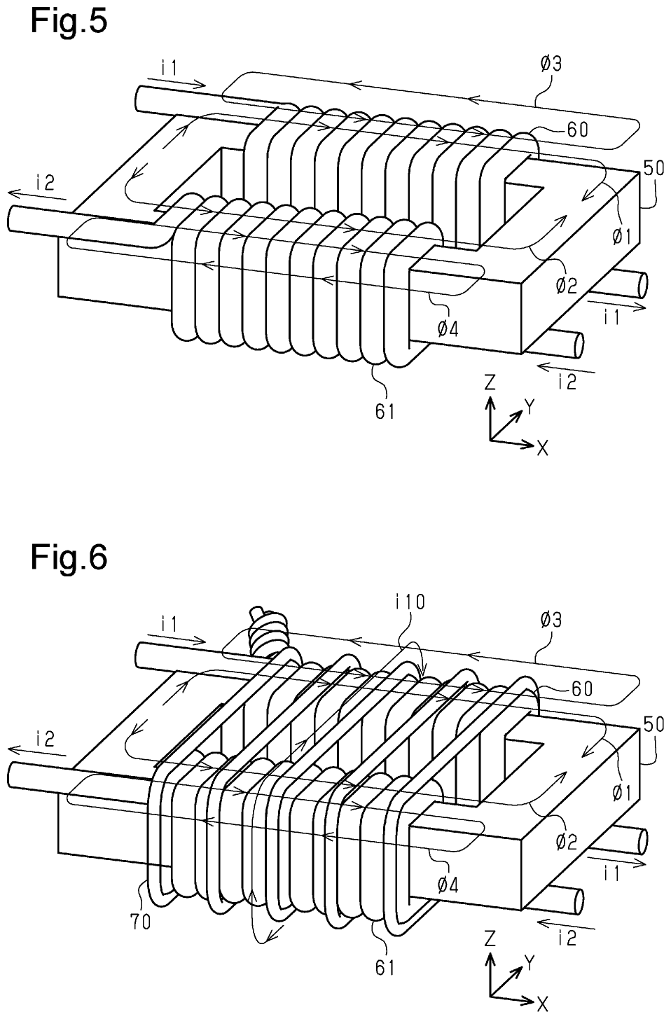

First, the normal mode (differential mode) will be described with reference to FIGS. 5 and 6.

As shown in FIG. 5, energization of the first winding 60 and the second winding 61 causes currents i1 and i2 to flow through the first winding 60 and the second winding 61. This generates magnetic fluxes φ1, φ2 in the core 50 and leakage magnetic fluxes φ3, φ4. The magnetic fluxes φ1, φ2 are opposite to each other. As shown in FIG. 6, an induced current (eddy current) i10 flows in the peripheral direction inside the enameled wire 70 so as to generate magnetic fluxes in the direction resisting the generated leakage flux φ3, φ4. The induced current flowing in the peripheral direction refers to a situation in which the induced current flows around the core 50.

In this manner, when leakage magnetic fluxes are generated by energization of the first winding 60 and the second winding 61, the induced current i10 flows in the peripheral direction inside the enameled wire 70 so as to generate a magnetic flux in a direction resisting the leakage magnetic fluxes.

In the common mode, energization of the first winding 60 and the second winding 61 causes currents to flow in the same direction through the first winding 60 and the second winding 61. This generates magnetic fluxes in the same direction in the core 50. In this manner, magnetic fluxes inside the core 50 maintain the common impedance.

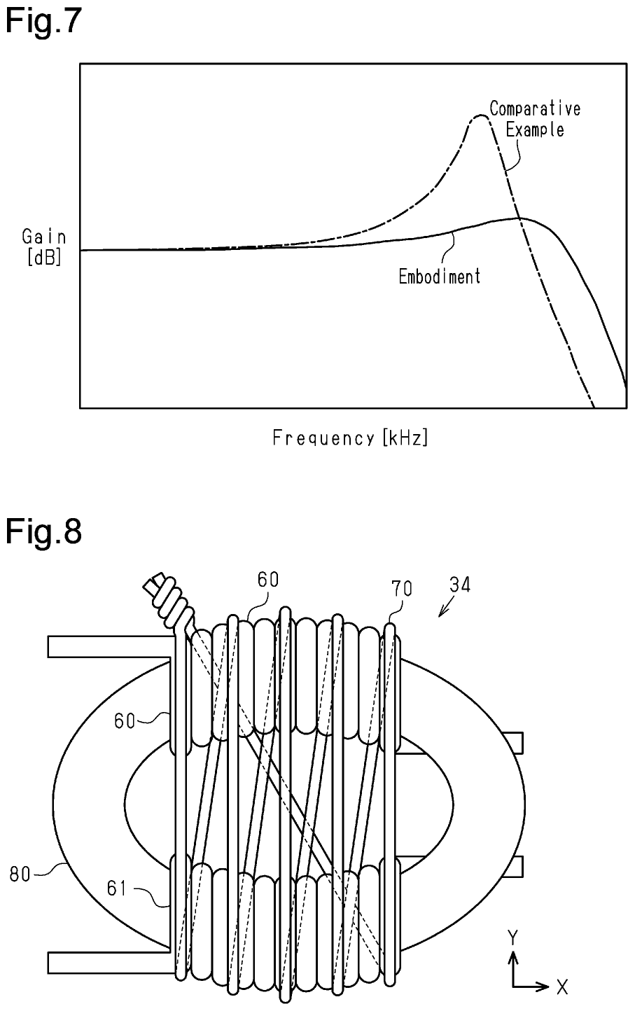

Next, the frequency characteristic of the low-pass filter circuit 36 will be described with reference to FIG. 7. FIG. 7 is a graph showing the frequency characteristic of the gain (attenuation amount) of the low-pass filter circuit 36 in relation to inflow normal-mode noise. The solid line in FIG. 7 represents the gain in a case in which the common mode choke coil 34 has an enameled wire 70, and the long dashed short dashed line in FIG. 7 represents the gain in the case in which the common mode choke coil 34 has no enameled wire 70. In FIG. 7, the frequency is plotted logarithmically on the horizontal axis. The gain is a type of parameter indicating an amount by which the normal mode noise can be reduced.

When the common mode choke coil 34 does not have the enameled wire 70, the Q factor of the low-pass filter circuit 36 (more specifically, the LC resonance circuit including the common mode choke coil 34 and the X capacitor 35) is relatively high as indicated by the long dashed short dashed line in FIG. 7. Therefore, the normal mode noise having the frequency close to the resonance frequency of the low-pass filter circuit 36 cannot be easily reduced.

In contrast, in the present embodiment, the common mode choke coil 34 has the enameled wire 70 at a position where an induced current is generated by magnetic fluxes (the leak magnetic fluxes φ3, φ4) generated in the common mode choke coil 34. The enameled wire 70 is provided at a position passing through the loops of the magnetic fluxes φ3, φ4 and is configured to generate an induced current (eddy current) by the leakage magnetic fluxes φ3, φ4. The induced current (eddy current) generates magnetic fluxes in a direction canceling the leakage magnetic fluxes φ3, φ4. As a result, the enameled wire 70 is used to lower the Q factor of the low-pass filter circuit 36. Thus, as indicated by the solid line in FIG. 7, the Q factor of the low-pass filter circuit 36 is low. Therefore, the normal mode noise having the frequency near the resonance frequency of the low-pass filter circuit 36 is also reduced by the low-pass filter circuit 36.

As described above, the common mode choke coil 34 has a metal shielding structure with the enameled wire 70. The common mode choke coil 34 is thus used in the low-pass filter circuit 36 to reduce common mode noise. Also, the common mode choke coil 34 positively uses the leakage magnetic fluxes generated in response to the normal mode current (differential mode current). Accordingly, the low-pass filter circuit 36 acquires an appropriate filtering performance with reduction in the normal mode noise (differential mode noise). That is, the use of the enameled wire 70 generates magnetic fluxes that resist the leakage magnetic fluxes generated by the flow of the normal mode current (differential mode current), and current flows in the enameled wire 70 by electromagnetic induction. The current is consumed as heat in the enameled wire 70. Since the enameled wire 70 functions as a resistance, a damping effect is obtained and the resonance peak generated by the low-pass filter circuit 36 is suppressed (see FIG. 7). Also, when the common mode current flows, the magnetic fluxes inside the core 50 maintain the common impedance.

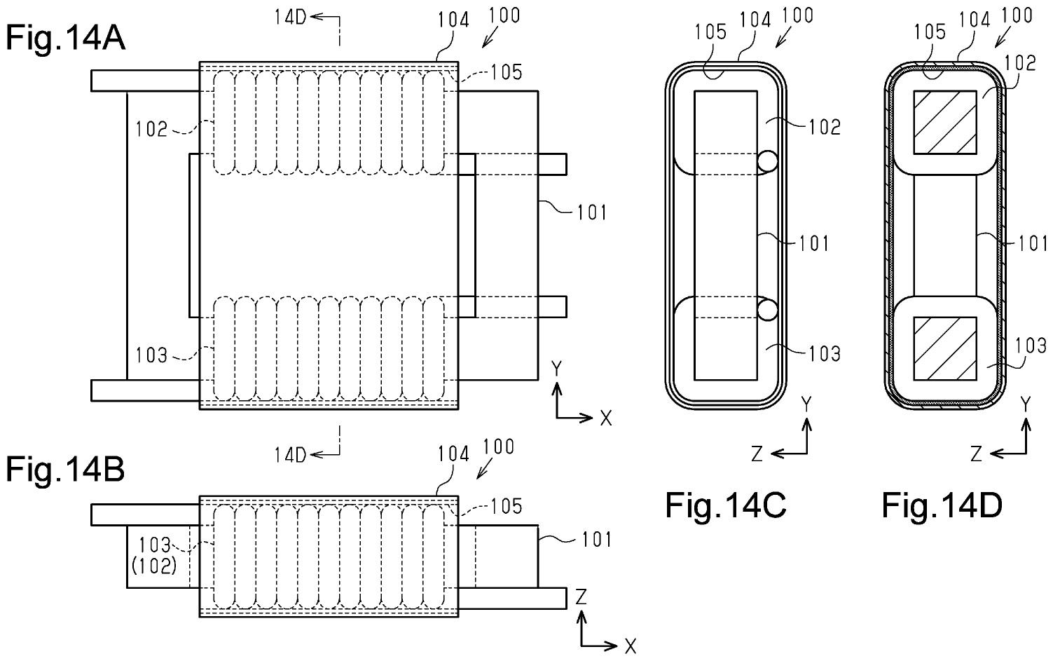

FIGS. 14A, 14B, 14C, and 14D show a comparative example.

In FIGS. 14A, 14B, 14C, and 14D, a common mode choke coil 100 includes an annular core 101, a first winding 102, a second winding 103, and an annular conductor 104. The first winding 102 is wound around the core 101. The second winding 103 is wound around the core 101. The conductor 104 covers the core 101 while extending over the first winding 102 and the second winding 103. The second winding 103 is opposed to the first winding 102 while being spaced apart from the first winding 102. The conductor 104 is a thin film. A plastic layer 105 is provided between the inner peripheral surface of the conductor 104 and the outer surfaces of the first and second windings 102, 103. The common mode choke coil 100 is used in an inverter device that drives an electric motor in an in-vehicle motor-driven compressor.

In the common mode choke coil 100 of the comparative example, the coil (windings 102, 103) are covered with the conductor 104, which is a thin film. Accordingly, when a normal-mode current flows, leakage magnetic flux is generated. The leakage magnetic flux in turn causes an induced current to flow through the conductor 104. The induced current is converted into a thermal energy in the conductor 104. The common mode choke coil 100 thus has a damping effect. In order for the common mode choke coil 100 to have a damping effect, the conductor 104 needs to have a certain degree of resistance value. Thus, a metal thin film of a thickness of 100 μm or less is used as the conductor 104. The conductor 104 is, for example, a copper foil. The thickness of the conductor 104 is 10 μm to 100 μm. Thickness of the conductor 104 is, for example, 35 μm. The reason for using a thin material as the conductor 104 is to increase the resistance against the current (induced current) in the conductor 104, thereby converting the current into heat. On the other hand, when the conductor 104 is thin, it is difficult to maintain the strength and the shape.

If the conductor 104 is made of a thin metal foil band, it is impossible to adjust the resistance value of the conductor 104 to an appropriate value since there is a narrow range of variation in thickness of commercially available metal foils. Also, the surface of the conductor 104 that contacts the coil (the windings 102, 103) needs to be insulated, which increases the required costs. Further, when the ends of a metal foil are joined to obtain the annular conductor 104, the joining operation needs to be executed so as to maintain the resistance value of the metal foil at a predetermined value. Accordingly, the shape of the joint must be optimized, and a production technology must be developed. Further, for example, holes need to be formed in the conductor 104 to ensure the heat radiation performance of the common mode choke coil 100. Each time the shape of the common mode choke coil 100 is changed, the conductor 104 needs to be customized in conformance to the changed shape. Further, the conductor 104 significantly reduces the inductance in the normal mode of the common mode choke coil 100 as compared to a case in which no conductor is provided.

In the present embodiment, the enameled wire 70 is wound in place of a metal foil (104). It thus suffices if a commonly marketed enameled wire is simply wound. This eliminates the need for customization and reduces the costs for components. Also, the resistance value can be finely adjusted by adjusting the diameter of the conductor and the number of turns of winding of the enameled wire 70. Since an enameled wire itself has an insulating layer, insulation is easily achieved. Since the gap G1 exists between each adjacent pair of the extending sections of the enameled wire, heat radiation performance is easily ensured. If the damping effect is the same, an enameled wire has a higher inductance in the normal mode than a metal foil. Further, the opposite ends of the electric wire of an enameled wire are joined to each other by any joining method such as soldering or mechanical swaging such as crimping after being twisted together. This eliminates the need for optimization of the shape of the joint and development of production technology, which would be needed in joining the ends of a metal foil.

The above-described embodiment has the following advantages.

(1) The in-vehicle motor-driven compressor 11 includes the inverter device 30, which drives the electric motor 19. The inverter device 30 includes the inverter circuit 31 and the noise reducing unit 32. The noise reducing unit 32 includes the common mode choke coil 34 and the X capacitor 35. The X capacitor 35, which is a smoothing capacitor, makes up the low-pass filter circuit 36 together with the common mode choke coil 34. The common mode choke coil 34 includes the annular core 50, the first winding 60, which is wound around the core 50, the second winding 61, which is wound around the core 50, and the enameled wire 70, which is a single coated conductive wire wound around the core 50. The second winding 61 is opposed to the first winding 60 while being spaced apart from the first winding 60. The enameled wire 70 surrounds the core 50 while extending over the first winding 60 and the second winding 61. The enameled wire 70 includes the circular wire 71, which is a copper electric wire, and the enamel 72, which is an insulating material coating the circular wire 71. The circular wire 71 is wound multiple turns around the core 50 so as to at least partly overlap with the first winding 60 and the second winding 61. The circular wire 71 is wound multiple turns around the core 50 about an axis extending in the extending direction of the core 50. The circular wire 71 has opposite ends, which are electrically connected to each other. The core 50 includes the exposed sections 53, 54, which are not covered with the enameled wire 70. The core 50 thus has a superior heat radiation performance. The enameled wire 70 is wound to surround the core 50, while extending over the first winding 60 and the second winding 61. Accordingly, when a normal-mode current flows, leakage magnetic fluxes are generated. The leakage magnetic fluxes in turn cause an induced current to flow through the enameled wire 70. The induced current is converted into a thermal energy in the enameled wire 70. The common mode choke coil 34 thus has a superior damping effect. Further, as compared to a configuration in which a winding is covered with a band-shaped conductor, a configuration in which a winding is surrounded by a narrow enameled wire has a superior heat radiation performance. The leakage magnetic fluxes generated from the first winding 60 and the second winding 61 form loops that pass through the exposed sections 53, 54 of the core 50 and intersect with the enameled wire 70. This readily allows an induced current to flow through the enameled wire 70. Since the generated leakage magnetic fluxes are generated, the normal mode choke coil can be omitted. The use of the enameled wire 70 ensures insulation.

(2) The enameled wire 70 includes the extending sections, which extend between the first winding 60 and the second winding 61. The core 50 includes the through-hole 59 on the inner side. On the surface of the core 50 in a front view of the through-hole 59, a gap G1 is provided between each adjacent pair of the extending sections of the enameled wire 70. The enameled wire 70 thus has a superior heat radiation performance.

(3) The core 50 has the first straight section 51 and the second straight section 52, which extend linearly so as to be parallel with each other. At least a part of the first winding 60 is wound around the first straight section 51, and at least a part of the second winding 61 is wound around the second straight section 52. Therefore, the enameled wire 70 can be arranged easily and is thus is practical.

The above described embodiment may be modified as follows. The above-described embodiment and the following modifications can be combined as long as the combined modifications remain technically consistent with each other.

A core of any shape other than a perfect circle can be used. For example, a core 80 having the shape of an ellipse shown in FIG. 8 may be used. The core 80 has a major axis extending along the X-axis in FIG. 8 and a minor axis extending along the Y-axis in FIG. 8. The windings 60, 61 are wound around two sections of the core 80 that extend along the major axis.

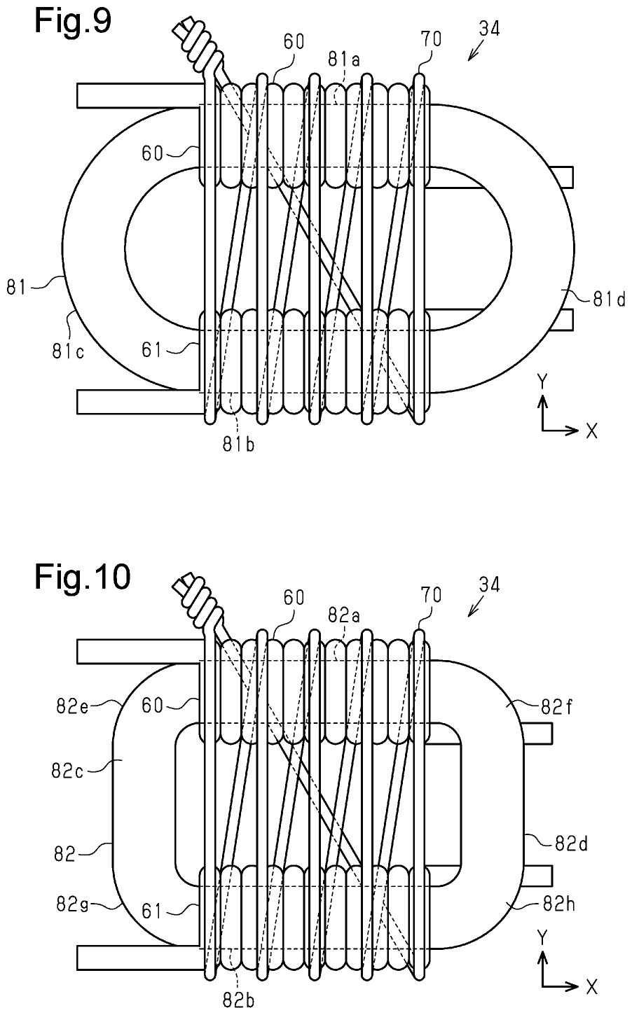

Alternatively, a core 81 having the shape of an elongated hole as shown in FIG. 9 may be used. That is, the core 81 includes straight sections 81a, 81b, which are parallel with each other, a semicircular section 81c, and a semicircular section 81d. The semicircular section 81c connects ends of the straight sections 81a, 81b on one side to each other. The semicircular section 81d connects ends of the straight sections 81a, 81b on the other side to each other. The windings 60, 61 are respectively wound around the straight sections 81a, 81b.

Alternatively, a core 82 having the shape of a rectangle with arcuate corners as shown in FIG. 10 may be used. That is, the core 82 includes long side sections 82a, 82b, which are parallel with each other, short side sections 82c, 82d, which are parallel with each other, and arcuate sections 82e, 82f, 82g, 82h, which connect adjacent pairs of the long side sections 82a, 82b and the short side sections 82c, 82d to each other. The windings 60, 61 are respectively wound around the long side sections 82a, 82b.

These cores are useful since these cores do not have the shape of a perfect circle when viewed in the axial direction, but have an extended shape. This is because an extended shape readily generates leakage magnetic fluxes and allows the leakage magnetic fluxes to have directional properties.

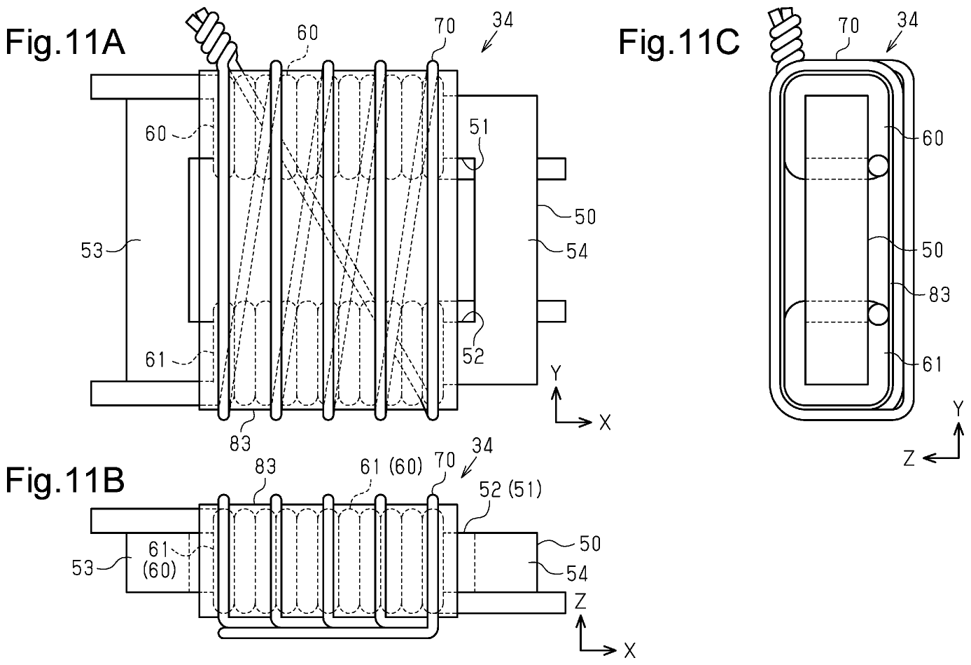

As shown in FIGS. 11A, 11B, 11C, an insulating plate 83 may be disposed between a side of the enameled wire 70 that is opposed to the core 50 and the outer surfaces of the first and second windings 60, 61. The insulating plate 83 may be, for example, a vinyl chloride tape. Since the insulating plate 83 is disposed on the side of the enameled wire 70 that is opposed to the core 50, the shape of the enameled wire 70 is maintained. Also, the insulating plate 83 ensures insulation between the enameled wire 70 and the windings 60, 61.

The above-described embodiment uses a coated conductive wire (70) that is obtained by coating a circular wire (71) having a cross-sectional shape of a perfect circle with an insulating material (72) as shown in FIG. 12A. However, other types of coated conductive wire may be used. For example, it is possible to use a coated conductive wire 75 shown in FIG. 12B that is obtained by coating a rectangular wire 76 having a rectangular cross section with an insulating material 77. In this case, the ends of the rectangular wire 76 simply need to be welded to each other after being stacked onto each other.

It suffices if the number of turns of the coated conductive wire is more than one.

### Second Embodiment

A second embodiment will now be described. Differences from the first embodiment will be mainly discussed.

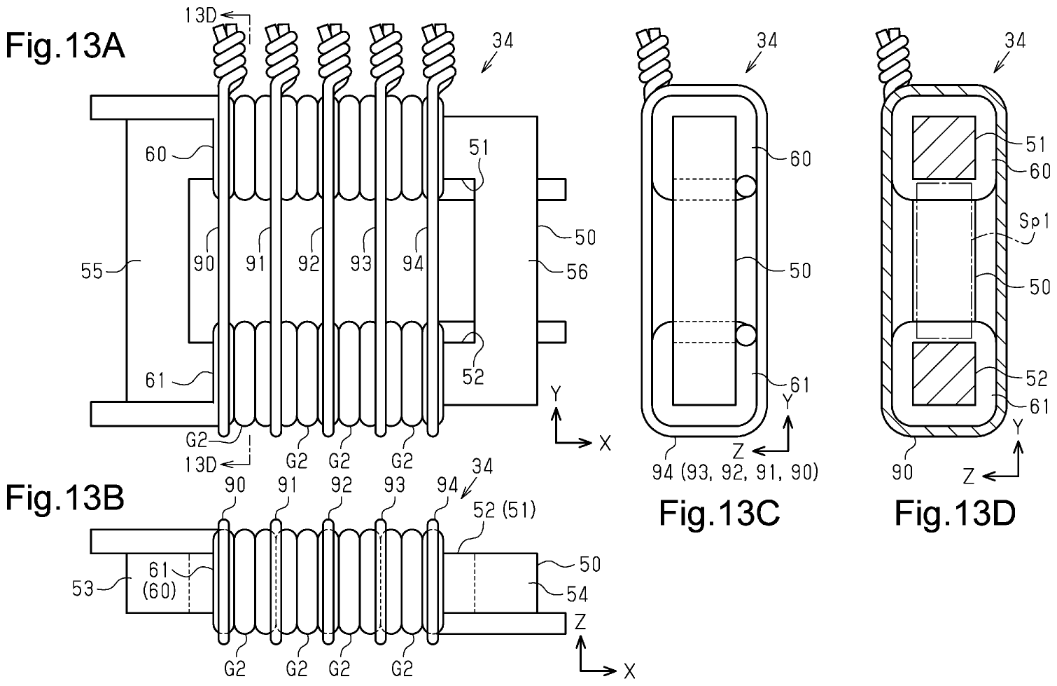

The second embodiment employs the structure shown in FIGS. 13A, 13B, 13C, and 13D instead of the structure shown in FIGS. 3A 3B, 3C, and 3D. Differences from the first embodiment will mainly be discussed below.

Referring to FIGS. 13A, 13B, 13C, and 13D, a common mode choke coil 34 of the present embodiment includes an annular core 50, a first winding 60, which is wound around the core 50, a second winding 61, which is wound around the core 50, and enameled wires 90, 91, 92, 93, 94, which are coated conductive wires wound around the core 50. The second winding 61 is opposed to the first winding 60 while being spaced apart from the first winding 60. The enameled wires 90, 91, 92, 93, 94 surround the core 50 while extending over the first winding 60 and the second winding 61. Although the present embodiment includes the five enameled wires 90, 91, 92, 93, 94, the number of enameled wires does not need to be five. Each of the enameled wires 90, 91, 92, 93, 94, for example, has the same structure as the enameled wire 70 shown in FIG. 12A.

At least one of the enameled wires 90, 91, 92, 93, 94 at least partly passes over the first winding 60 and the second winding 61.

Each of the enameled wires 90, 91, 92, 93, 94 is wound one turn around the core 50. One end and the other end of the circular wire 71 (refer to FIG. 12A) of the each of the enameled wires 90, 91, 92, 93, 94 are electrically connected to each other by being twisted together. In a broad sense, each of the enameled wires 90, 91, 92, 93, 94 is wound one or more turns around the core 50. The ends of the circular wire 71 may be soldered to each other after being twisted together.

The first winding 60 is wound around the first straight section 51 of the core 50, and the second winding 61 is wound around the second straight section 52 of the core 50. The core 50 thus includes exposed sections 55, 56, which are not covered with the enameled wires 90, 91, 92, 93, 94. A gap G2 (refer to FIGS. 13A and 13B) is provided over the entire perimeter between each adjacent pair of the enameled wires 90, 91, 92, 93, 94 in a wound state.

The enameled wires 90, 91, 92, 93, 94 are arranged in the extending direction of the core 50 (X-direction) as viewed in FIG. 13A. The enameled wires 90, 91, 92, 93, 94 are evenly disposed in the extending direction of the core 50 (X-direction) as viewed in FIG. 13A.

The enameled wires 90, 91, 92, 93, 94 extend in the Y-direction, which is orthogonal to the extending direction of the core 50 in FIG. 13A (X-direction), and are parallel with each other.

The present embodiment has the following advantages.

(4) The common mode choke coil includes the annular core 50, the first winding 60, which is wound around the core 50, the second winding 61, which is wound around the core 50, and enameled wires 90, 91, 92, 93, 94, which are coated conductive wires wound around the core 50. The second winding 61 is opposed to the first winding 60 while being spaced apart from the first winding 60. The enameled wires 90, 91, 92, 93, 94 surround the core 50 while extending over the first winding 60 and the second winding 61. Each of the enameled wires 90, 91, 92, 93, 94 is wound one or more turns around the core 50, and one end and the other end of each circular wire 71, which is an electric wire, are electrically connected to each other. The core 50 includes the exposed sections 55, 56, which are not covered with the enameled wires 90, 91, 92, 93, 94.

The core 50 includes the exposed sections 55, 56, which are not covered with the enameled wires 90, 91, 92, 93, 94. The core 50 thus has a superior heat radiation performance. The enameled wires 90, 91, 92, 93, 94 are wound to surround the core 50 while extending over the first winding 60 and the second winding 61. When a normal-mode current flows, leakage magnetic fluxes are generated. The leakage magnetic fluxes in turn cause induced currents to flow through the enameled wires 90, 91, 92, 93, 94. The induced currents are converted into thermal energy in the enameled wires 90, 91, 92, 93, 94. The common mode choke coil 34 thus has a superior damping effect. The leakage magnetic fluxes generated from the first winding 60 and the second winding 61 form loops that pass through the exposed sections 55, 56 of the core 50 and intersect with the enameled wires 90, 91, 92, 93, 94. This readily allows an induced current to flow through the enameled wires 90, 91, 92, 93, 94. Since the generated leakage magnetic fluxes are generated, the normal mode choke coil can be omitted. The use of the enameled wires 90, 91, 92, 93, 94 ensures insulation.

(5) The gap G2 is provided over the entire perimeter between each adjacent pair of the enameled wires 90, 91, 92, 93, 94 in a wound state. The core 50 thus has a superior heat radiation performance.

Although the core 50 has a rectangular shape as shown in FIG. 13A, the shape of the core 50 is not limited to this. It is possible to use the elliptic core 80 shown in FIG. 8, the core 81 having the shape of an elongated hole shown in FIG. 9, or the core 82 having a rectangular shape with arcuate corners as shown in FIG. 10. Also, in place of the enameled wire 70 shown in FIG. 12A, it is possible to use the coated conductive wire 75, which is obtained by coating the rectangular wire 76 having a rectangular cross section with the insulating material 77 as shown in FIG. 12B. In this case, the ends of the rectangular wire 76 simply need to be welded to each other after being stacked onto each other.

In the second embodiment, the insulating plate 83 shown in FIGS. 11A, 11B, 11C may be used.

The above described embodiments may be modified as follows.

The method of electrically connecting one end and the other end of an electric wire in a coated conductive wire is not particularly limited. The stripped opposite ends of the electric wire may simply be twisted together, crimped together, or welded together.

The enameled wires (71, 76) of the enameled wires 70, 90, 91, 92, 93, 94, which are coated conductive wires, may be made of aluminum instead of copper.

The insulating material (72, 77) of the coated conductive wires may be made of polyimide, polyester, PET, PEN, or the like, instead of enamel.

The coated conductive wire does not need to be an enameled wire. For example, the coated conductive wire may be a vinyl chloride cable.

The extending sections of the enameled wire 70 in FIG. 3A do not need to be evenly disposed in the extending direction of the core 50 (X-direction). The same applies to the case of FIG. 13A. That is, the enameled wires 90, 91, 92, 93, 94 do not need to be evenly disposed in the extending direction of the core 50 (X-direction).

The enameled wire 70 and the enameled wires 90, 91, 92, 93, 94 extend in the Y-direction, which is orthogonal to the extending direction of the core 50. However, the enameled wire 70 and the enameled wires 90, 91, 92, 93, 94 may extend diagonally with respect to the Y-direction.

The extending sections of the enameled wire 70 do not need to be parallel with each other in FIG. 3A. Likewise, the enameled wires 90, 91, 92, 93, 94 do not need to be parallel with each other in FIG. 13A.

The clearance (the gap G1) between each adjacent pair of the extending sections of the enameled wire 70 in FIG. 3A may be omitted. The clearance (the gap G2) between each adjacent pair of the enameled wires 90, 91, 92, 93, 94 in FIG. 13A may be omitted.

In the first embodiment, the extending sections of the enameled wire 70 are arranged in the extending direction of the core 50 (X-direction). However, the extending sections may be wound to be overlapped with each other in the direction orthogonal to the extending direction of the core 50 (the Y-direction) at the same position in the extending direction of the core 50 (the X-direction). That is, the enameled wire 70 may be wound to be arranged either side by side or on top of each other. The same applies to the enameled wires 90, 91, 92, 93, 94.

The filtering performance of the low-pass filter circuit 36 can be easily adjusted by changing, for example, the number of turns or the diameter of the electric wire of the enameled wire 70, or by changing, for example, the number of the enameled wires 90, 91, 92, 93, 94 or the diameter of the conductive wires of the enameled wires 90, 91, 92, 93, 94.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An in-vehicle motor-driven compressor comprising:
a compression unit configured to compress fluid;
an electric motor configured to drive the compression unit; and
an inverter device configured to drive the electric motor, wherein
the inverter device includes:
an inverter circuit configured to convert DC power to AC power, and
a noise reducing unit that is provided on an input side of the inverter circuit and is configured to reduce common mode noise and normal mode noise included in the DC power before the DC power is supplied to the inverter circuit,
the noise reducing unit includes:
a common mode choke coil, and
a smoothing capacitor that makes up a low-pass filter circuit together with the common mode choke coil,
the common mode choke coil includes:
an annular core that includes a through-hole,
a first winding wound around the core,
a second winding wound around the core, the second winding being opposed to the first winding while being spaced apart from the first winding, and
a single coated conductive wire that is wound around the core so as to surround the first winding, the second winding, and the core, the coated conductive wire including sections that are opposed to each other with the through-hole in between,
the coated conductive wire includes an electric wire and an insulating material coating the electric wire,
the electric wire is wound multiple turns around the core so as to at least partly overlap with the first winding and the second winding,
one end and another end of the electric wire are electrically connected to each other, and
the core includes an exposed section that is not covered with the coated conductive wire.

2. The in-vehicle motor-driven compressor according to claim 1, wherein
the coated conductive wire includes extending sections that extend between the first winding and the second winding, and
a gap is provided between an adjacent pair of the extending sections.

3. The in-vehicle motor-driven compressor according to claim 2, wherein, on a surface of the core in a front view of the through-hole, the gap is provided between each adjacent pair of the extending sections.

4. An in-vehicle motor-driven compressor comprising:
a compression unit configured to compress fluid;
an electric motor configured to drive the compression unit; and
an inverter device configured to drive the electric motor, wherein
the inverter device includes:
an inverter circuit configured to convert DC power to AC power, and
a noise reducing unit that is provided on an input side of the inverter circuit and is configured to reduce common mode noise and normal mode noise included in the DC power before the DC power is supplied to the inverter circuit,
the noise reducing unit includes:
a common mode choke coil, and
a smoothing capacitor that makes up a low-pass filter circuit together with the common mode choke coil,
the common mode choke coil includes:
an annular core that includes a through-hole,
a first winding wound around the core,
a second winding wound around the core, the second winding being opposed to the first winding while being spaced apart from the first winding, and
multiple coated conductive wires that are wound around the core so as to surround the first winding, the second winding, and the core, the coated conductive wires including sections that are opposed to each other with the through-hole in between,
the coated conductive wires each include an electric wire and an insulating material coating the electric wire,
each of the coated conductive wires is wound one or more turns around the core,
one end and an other end of the electric wire are electrically connected to each other for each of the coated conductive wires, and
the core includes an exposed section that is not covered with any of the coated conductive wires.

5. The in-vehicle motor-driven compressor according to claim 4, wherein a gap is provided over an entire perimeter between an adjacent pair of the coated conductive wires.
